(19) United States
(12) Patent Application Publication
(10) Pub. No.: US 2017/0215502 A1
(43) Pub. Date: Aug. 3, 2017

(54) Method to Apply Reflective Material on an Outer Garment

(71) Applicant: Thomas D. Jones, JR., Hanson, KY (US)

(72) Inventor: Thomas D. Jones, JR., Hanson, KY (US)

(21) Appl. No.: 15/011,722

(22) Filed: Feb. 1, 2016

(51) Int. Cl. A41D 31/00; B32B 38/00; B32B 5/02; A41D 3/00; B32B 27/30; A41D 13/01; A41B 1/08; A41D 1/06; B32B 37/18; B32B 27/08

(52) U.S. Cl. CPC A41D 31/0088; B32B 37/182; B32B 38/0004; B32B 5/024; B32B 27/08; B32B 27/30; A41D 13/01; A41B 1/08; A41D 1/06; A41D 3/00; B32B 2307/416; B32B 2437/00; A41D 2400/60

(57) ABSTRACT

Applying significant reflective material to stretchy textile materials by reducing the size of each individual reflective surface to a plurality of very small size pieces and allowing plenty of stretch room between the small reflective surfaces. The small reflective surfaces combined to display a selected design on the article of clothing. The method generally comprises (a) cutting or dividing a reflective material into many small pieces; (b) arranging the plurality of small reflective pieces on the stretchy material forming a larger pattern that makes a discernable design/word; and, (c) appropriately applying the small reflective pieces to the stretchy material.

### CROSS REFERENCES TO RELATED APPLICATIONS

U.S. Provisional Application for Patent No. 62/112,699, filed Feb. 6, 2015, with title “Reflective Outer Garment” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable.

### BACKGROUND OF THE INVENTION

1. Field of the Invention

The present invention pertains to articles of clothing that display a reflective design and to a method of applying reflective material on stretchable materials and fabrics.

2. Brief Description of Prior Art

Following an extensive period of selling traditional striped reflective clothing for use in underground mines, as well as 4-way stretch (UnderArmour-type) garments or for athletic garments such as what athletes wear for exercise and athletic events, there is a need in the market for those stretchy garment materials as reflective outer garments.

The traditional reflective material on stretchable or elastic materials and fabrics has several complexities and drawbacks regarding both the method with which the application is performed, as well as the results obtained once the process is completed. In fact, one of the inconveniences to be noticed, is the cracking that occurs in the standard reflective material once it has been adhered to the stretchable material or fabric. Said cracking affects the reflective efficiency of the product, its lifespan, and its end appearance in a substantial manner.

The use of reflective material on outer garments has become increasingly popular, due to the importance of visualizing and identifying properly the things surrounding us, which is especially relevant on the street, with regard to pedestrians, cyclists, walkers, and motorcyclists. It is also important in the workplace such as, for example, in and around mines.

Traditional reflective work clothes are striped using 2 basic processes, neither of which allow the 4-way stretch material to flex the way it is intended while staying intact. What is needed is a method of applying a significant (as defined by various company policies as well as ANSI and DOT standards/levels) reflective surface to stretchy textile materials in a way that would be both durable and not constrict the material's desirable ultra-flexible attributes.

As mentioned, garments with significant amounts of reflective surface (required for low light applications like underground mining, night/road construction, first responder, etc.) previously fell into primarily 1 of 2 categories. Both categories tend to be comprised of outer and mid layer garments including shirts, pants, safety vests overalls, coveralls, coats, jackets, and other similar garments with reflective striping added in the following ways:
1) Garments (mostly standard cotton or poly-blend work garments) have a reflective/hi-vis tape sewn onto them. Many, if not most of these type garments use a 3M reflective tape or similar product that has a ½″-1″ silver reflective stripe in the middle of a hi-vis green or orange cotton tape that is between 2-3″ in width. This reflective tape can be bought on a roll and sewed to anything from jeans to t-shirts. Many companies produce these garments and sew the tape onto the dimensioned fabric pieces before the garment is finally assembled. Other companies purchase finished garments and sew on the tape as a secondary process with or without the knowledge of the original garment manufacturer. Almost all heavy-duty, commercial laundry ready reflective work clothes are done this way.
2) Heat adhesive applique silver reflective tape between 1-3″ wide is ironed on to the garment. The most common mass-produced versions of this are hi-vis reflective shirts, safety vests, sweatshirts, and hoodies. These garments are already hi-vis orange or green and tend to be of the 2-way stretch variety. Typically, the silver tape is applied from top to bottom of the shirt on both front and back, spaced evenly between shoulders and center of the body like suspenders then also wrapped around horizontally like a high belt between navel and sternum. On long-sleeve, and some short sleeve shirts, stripes can be added to the sleeves as well. Some companies apply tape before final assembly of the garment and other companies or individuals apply after finished garment has been purchased with or without the consent of the manufacturer. This tape can be purchased by the roil and is manufactured by many companies. The heat transfer process requires only a heat source such as an iron or steam press.

The major problem with utilizing either of these two prominent methods of reflective surface application is that both types of tape restrict the movement of the fabric they are applied to. In the case of #1, there is absolutely no stretch in any direction. This is essentially a 2″ wide piece of cotton fabric, reinforced with a ¾″ poly reflective stripe, anchored with a standard stitch pattern to an unstretched garment. So, when the garment is stretched in any direction, the reflective tape turns into a binder much like a restraining strap. The heat applique tape isn't much better. Instead of being sewed on, it is anchored in place across its entire bottom surface. In order to stretch it has to break. So, if made thick and durable, the garment won't stretch; if made thinner, the tape will crack up into uneven pieces and allow the garment to stretch only where the tape has broken.

Method #1 makes a good, durable traditional work uniform that tends to last and maintain its reflectivity over time, even when subjected to washing and heavy work environments. Method #2 makes an effective and cheap reflective t-shirt that will crack and fade in a relatively short time. However, neither methods are particularly suitable for 2-way stretch application, let alone 4-way stretch fabrics.

There are also a couple other less prominent methods for applying a reflective surface to garments. These include sewing on a type of reflective tape that has reflective surface embedded inside of a plastic “sheath”, This tape is also typically between 1-3″ wide but comes in many colors. It is very shiny and can be colorful and does not use the same type of traditional silver reflective surface as other forms of textile reflective tapes. It is widely used on dog collars, suspenders, belts, backpacks, and similar accessories-rarely used on clothing because of its weight, bulk, and cost.

Some clothes are also screened with a reflective “paint”. This process is essentially a silk screen using a more expensive reflective paint than the standard colored paint used on everyday t-shirts. This is usually put down on t-shirts in the 1-3″ silver band format and looks much like #2 heat applique tape product above. It is painted on wet then dried with light heat. The nature of this screened material is that it tends to crack up easily when stretched like the heat applique tape, especially if applied in the quantity needed for a highly reflective garment.

Finally, smaller reflective accents are often added to many products, especially athletic wear and coats. These can be made in many different ways but are all similar in that the total reflective surface is minimal (usually less than 6 sq. in, on the entire garment). This cannot be considered highly reflective material due to such limited reflective surface.

### SUMMARY OF THE INVENTION

A novel method for applying a reflective material on an outer garment. The process disclosed applies a reflective material to a tight-fitting, ultra-flexible, moisture wicking, performance enhancing garment that generates a reflective design at night or in low light situations with the confidence of unprecedented reflectivity and stylized design capability becoming of these modern fabrics. Companies have applied their logo or one small line (less than a couple square inches) onto running clothes. Others have made contiguous designs (like lettering or large objects) out of reflective material and adhered it to regular shirts that aren't particularly stretchy. However, the present disclosure conquers the stretchy reflective problem by breaking up their design and reflective surface into many very small points to create the massive, durable reflective effect of the present invention.

Ultimately, it has been conceived a method with which it is possible to apply a reflective material on stretchy or elastic materials, bodies of fabrics (e,g.: polyester, elastan, nylon, and spandex, among others) (hereinafter referred to as “stretchy material”' or “stretchy garment”), allowing this material to be subjected to multiple stretching without suffering any damage; ensuring a homogenous and uniform application of the reflective material, hence avoiding creases; achieving an approved volume of the amount of reflective material to be used on the stretchy material; and, that allows the reflective material to keep its characteristics, its shape and end appearance. In accordance with the latter, the method object of this patent application can be used in the manufacture of garments such as trousers, jackets, shirts and t-shirts, among others.

### BRIEF DESCRIPTION OF THE DRAWINGS

FIG. 1 is a process flow diagram illustrating the preferred embodiment, a reflective outer garment.

### DESCRIPTION OF THE PREFERRED EMBODIMENT

The present invention is for applying a significant reflective surface to stretchy materials. The invention uses reflective materials to achieve the goals of allowing the garment to stretch as well as be durable while maintaining the desired amount of total reflective surface. More particularly, the disclosed method relates to a method of applying a significant reflective surface to materials in a way that would be both durable and not constrict the material's desirable ultra-flexible attributes. In the broadest context, the method herein consists of components and steps configured with respect to each other so as to attain the desired objective.

All previously exposed results are possible through the method object of this application, which allows applying the reflective material on various materials. The method generally comprises the following steps: (a) cutting or dividing a reflective material into many small pieces; (b) arranging the plurality of small reflective pieces on the stretchy garment forming a larger pattern that makes a discernable design/word; and, (c) appropriately applying the reflective material to the stretchy garment.

From the outset it should be understood that while the present method is generally described for applying a reflective material to a stretchy material or garment, the present invention works equally well on less stretchy or non-stretchy materials such as, but not limited to, cotton or poly-blend materials. Further while the description primarily refers to applying the reflective material to a garment, it should be understood that the present method includes applying the reflective material to objects made of a fabric that are not outer garments. As such, application of the present invention to a fabric material includes all articles that are constructed of a fabric material.

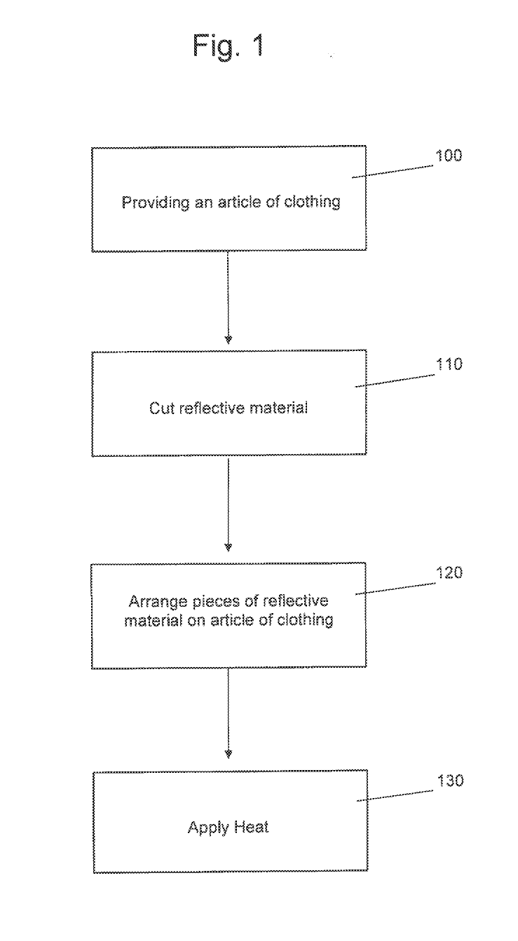

Referring to FIG. 1, which describes one embodiment of the present invention, a shirt 100 made of a Lycra, spandex, polyester blend was used. Then, dividing 110 a silver reflective vinyl heat applique material (used to make the tape in method #2 described above) into a plurality of small pieces, and then arranging 120 the plurality of small pieces into a larger selected pattern that makes a discernable design/word like a pointillist mosaic. Then, heat-apply 130 the arranged small reflective pieces to the shirt in a wrap-around design.

Access to the reflective material is available in various size sheets known in the art. The smaller pieces described may be cut or divided in hexagon or diamond configurations. However, better results were obtained dividing the reflective material in small circles having a less than ½ inch diameter. Small circle configurations were found to be the least difficult to divide, arrange, and iron into place.

As should be understood, different shirt panels (front, back, sleeves) in various sizes (S-XXL) required their own die-cut mosaic of dots made and applied, then the assemblage of dots had to be assembled carefully to allow for the wrap-around designs on the stretchy garment to be contiguous. The end result are stretchy shirts that have hundreds of square inches of reflective surface (enough to meet the requirements of any work site, night time athlete, or emergency worker and much greater than most traditional reflective clothing) while still allowing the garment to stretch, compress, and otherwise perform as it is supposed to.

This method for applying a significant reflective surface to stretchy materials can be modified from the specific procedure outlined above in many ways. What is important is (a) to reduce the size of each individual reflective surface to a plurality of very small size pieces or dots preferably having a diameter of about ½ inch, but not less than a pinpoint (about 5 thousandths of an inch (0.005″)) in diameter, and not more than a 6 inch diameter, preferably not more than about a 1 inch diameter, and (b) include a slight spacing between the small pieces to allow plenty of stretch room in between the small reflective surfaces. It is important that there are enough of the small reflective surfaces to produce the composite reflective effect and they are thick, durable, and anchored well.

One could also use a screening process to apply the reflective material instead of dividing heat-applied vinyl as described and applying by iron. The small reflective surfaces (or “dots”) could be any shape: such as hexagons to make a beehive look or little smiley faces, company logos, etc. The dots could make any shape, word, or message imaginable. This method could be applied to any type of stretch material such as: lycra, cotton, spandex, nylon, polyester, latex, rubber, etc. And could be used to make almost any existing product reflective: athletic garments, panty hose, swim wear, biking clothes, socks, hats, etc.

Therefore, and in accordance with the state of the art, there is no previous method that allows the manufacturer of reflective products with similar features, advantages, end appearance, quality and efficiency, as offered by the method here described through this application, improving substantially all known in this field, so far.

Although the above description contains many specificities, these should not be construed as limiting the scope of the invention but as merely providing illustrations of some of the presently preferred embodiments of this invention. As such, it is to be understood that the present invention is not limited to the embodiments described above, but encompasses any and all embodiments within the scope of the claims.

It would be obvious to those skilled in the art that modifications may be made to the embodiments described above without departing from the scope of the present invention. Thus the scope of the invention should be determined by the appended claims in the formal application and their legal equivalents, rather than by the examples given.

I claim:

1. A method to apply reflective material on a material, which method comprising the steps of:
dividing a reflective material in to a plurality of small reflective pieces,
arranging the plurality of small reflective pieces on a material forming a selected larger pattern,
applying the arranged reflective pieces to the material.

2. The method according to claim 1, wherein said plurality of small reflective pieces having a circular configuration.

3. The method as recited in claim 1, wherein the size of each of said small reflective pieces has less than a ½ inch diameter.

4. The method as recited in claim 1, wherein the size of each of said small reflective pieces is not more than a 6 inch diameter.

5. The method as recited in claim 1, wherein the size of each of said small reflective pieces is not more than a 1 inch diameter.

6. The method as recited in claim 1, wherein the diameter of each of said small reflective pieces is between 0.005″ and 6 inches.

7. The method as recited in claim 1, wherein said step of arranging the reflective pieces includes having a spacing between each of the plurality of small reflective pieces.

8. The method as recited in claim 1, wherein said reflective material is heat-applied vinyl.

9. The method as recited in claim 1, wherein said reflective material is a reflective tape.

10. A method to apply reflective material on fabrics comprising the steps of:
separating a reflective material in to a plurality of small reflective pieces,
each of said small reflective pieces having a similar shape,
arranging the plurality of small reflective pieces on a fabric forming a selected larger pattern, wherein a spacing is defined between the small reflective pieces,
applying the arranged reflective pieces to the fabric.

11. The method according to claim 10, wherein said shape is a circular configuration.

12. The method as recited in claim 10, wherein the size of each of said small reflective pieces has less than a ½ inch diameter.

13. The method as recited in claim 10, wherein the size of each of said small reflective pieces is not more than a 6 inch diameter.

14. The method as recited in claim 10, wherein the size of each of said small reflective pieces is not more than a 1 inch diameter.

15. The method as recited in claim 10, wherein the diameter of each of said small reflective pieces is between 0.005″ and 6 inches.

16. The method as recited in claim 10, wherein said shape is a hexagon shape.

17. The method as recited in claim 10, wherein said shape is a diamond shape.

18. The method as recited in claim 10, wherein said reflective material is vinyl.

19. The method as recited in claim 10, wherein said reflective material is a reflective tape.

20. A method of applying reflective material on fabrics comprising the steps of:
dividing a sheet of reflective material into a plurality of small reflective pieces having a similar shape and having a diameter of between 0.005″ and 6 inches,
arranging the plurality of small reflective pieces on a fabric with a spacing between the reflective pieces,
applying the arranged reflective pieces to the fabric.
